(19) United States
(12) Patent Application Publication
(10) Pub. No.: US 2016/0374510 A1
(43) Pub. Date: Dec. 29, 2016

(54) GAS GRILL

(71) Applicant: COPRECITEC, S.L., Aretxabaleta (ES)

(72) Inventor: Inigo ALBIZURI LANDAZABAL, Muxika (ES)

(21) Appl. No.: 14/969,307

(22) Filed: Dec. 15, 2015

(30) Foreign Application Priority Data
Jun. 29, 2015 (ES) P201530934

(51) Int. Cl. A47J 37/07; F23N 1/00; F24C 3/12; F23D 14/10

(52) U.S. Cl. CPC A47J 37/0713; F23D 14/10; F23N 1/007; F24C 3/124

(57) ABSTRACT

A gas grill according to one embodiment comprising a structure and a lid, a cooking chamber, a cooking surface in the cooking chamber comprising at least a first area and a second area, at least one heat source below the first area comprising at least one burner, and a gas valve fluidically connected with the burner, the gas valve regulating the rate of the gas flow towards the burner and comprising a highest gas flow rate regulating configuration which allows foods arranged in the first area of the cooking surface to be seared. The gas valve being a thermostatic gas valve which allows automatically regulating a temperature selected for the cooking chamber.

### CROSS-REFERENCE TO RELATED APPLICATIONS

This application relates to and claims the benefit and priority to Spanish Application No. P201530934, filed Jun. 29, 2015.

### TECHNICAL FIELD

The present invention relates to grills, and more specifically to household gas grills.

### BACKGROUND

Gas grills are used outside the home and comprise a cooking surface that is usually divided into different areas making up a multipurpose cooking surface. The grills comprise different heat sources arranged below the cooking surface, which allow cooking foods arranged in any of the different areas of the cooking surface in a combined manner. Furthermore, some grills comprise a lid which forms a cooking chamber when the lid is closed over the structure of the grill.

Grills comprising a heat source below one of the areas into which the cooking surface is divided, which allows preparing seared foods, are known. This entails applying direct and intense heat to foods, causing the foods to rapidly cook on the outside but not on the inside. Therefore, the juices of the foods are sealed into the foods. This can be done in several ways, for example by using heat sources comprising infrared burners, which produce the intense heat required for sealing the foods. However, such burners are not suitable for cooking foods conventionally. Another way to prepare seared foods is by means of heat sources comprising a standard gas burner in combination with a variable flow control gas valve, which has an increased-capacity gas flow regulating position. This allows preparing seared foods and also being able to prepare foods conventionally by adjusting the valve to a lower gas flow position.

This preparation of seared foods is one of the ways of preparing foods by means of what is referred to as direct cooking. This direct cooking system is similar to grilling, where the foods, for example chops, steaks, sausages, vegetables, etc., are cooked directly over the heat source. Direct cooking is used for cooking foods in a time of no more than 20 minutes for example. The cooking surface is usually preheated with all the heat sources on maximum for a given time, and then the necessary heat sources are adjusted to the temperature required by the recipe for the foods to prepare, placing the foods on the cooking surface. If the grill has a lid, the lid is closed and is only opened to check the state of the foods or to flip them over, and at the end of the cooking time.

Another way of preparing foods is referred to as indirect cooking. This indirect cooking system is similar to oven roasting, where the foods, for example ribs, meat for roasting, whole chickens, turkeys and other large pieces of meat, as well as whole fish or fish fillets, are cooked removed from the heat sources. Indirect cooking is used for cooking foods in a time of more than 20 minutes for example. The lid of the grill is closed, and is pre-heated the cooking surface with all the heat sources on maximum for a given time, and then the necessary heat sources are adjusted to the temperature required by the recipe for the foods to prepare, placing the foods on the cooking surface in an area below which the heat source is not switched on. Therefore, the heat inside the cooking chamber increases, is reflected on the lid and on the inner surfaces of the grill, and the foods are cooked slowly, heat circulating in the cooking chamber like in a convection oven.

US2009/314278 A1 describes a gas grill, comprising a support structure and a lid, a cooking chamber comprised between the inside of the structure and the lid closed over the structure, a cooking surface arranged in the cooking chamber, the cooking surface comprising at least two areas, heat sources arranged below the cooking surface and the heat sources comprising at least one burner and a gas valve fluidically connected with the burner, the gas valve being manually manipulated by a user for regulating the rate of the gas flow coming from a gas supply source towards the burner, the gas valve comprising a highest gas flow rate regulating position which allows foods arranged in the first area of the cooking surface to be seared.

### SUMMARY OF THE DISCLOSURE

According to one implementation a gas grill is provided that comprises a support structure and a lid, a cooking chamber comprised between the inside of the structure and the lid, the lid being moveable between an open position and a closed position. A cooking surface is arranged in the cooking chamber, the cooking surface comprising at least a first area and a second area, at least one heat source arranged below the cooking surface, the at least one heat source being below the first area, and the at least one heat source comprising at least one burner and a gas valve fluidically connected with the burner, the gas valve regulating the rate of the gas flow coming from a gas supply source towards the burner, the gas valve comprising a highest gas flow rate regulating position which allows foods arranged in the first area of the cooking surface to be seared. The gas valve is a thermostatic gas valve which allows automatically regulating a temperature selected for the cooking chamber, for cooking foods arranged on the cooking surface.

The heat source comprises a burner and a valve fluidically connected to the burner, with a gas flow rate regulating position which allows searing foods, and therefore allows direct cooking of the foods, arranged over the burner. The valve is thermostatic and therefore allows automatically regulating a temperature selected for the cooking chamber. This means that by selecting the required temperature in the cooking chamber the foods arranged in the second area of the cooking surface below which there is no heat source, or if there is one it is switched off, can be cooked indirectly like in a conventional oven. This dual function of direct cooking, which includes searing foods, and indirect cooking like in an oven in the cooking chamber of the grill is achieved with a single thermostatic valve fluidically connected to a standard burner, which further lowers costs of the grill given how simple the solution is.

These and other advantages and features will become evident in view of the drawings and the detailed description.

### BRIEF DESCRIPTION OF THE DRAWINGS

FIG. 1 shows a perspective view of a grill according to one embodiment.

FIG. 2 shows a plan view of the grill of FIG. 1, in which the lid and the grill grate used as a cooking surface have been removed.

FIG. 3 illustrates a partial cross-section view of the grill of FIG. 1 with the lid closed, showing the burner and the thermostatic gas valve of the heat source for searing foods.

FIG. 4 shows a partial rear perspective view of the control panel with the gas valves and respective burners of the grill of FIG. 1, as well as the connection of the grill gas distributor with the gas supply.

FIG. 5 shows a front view of an embodiment of the control knob of the thermostatic gas valve of the heat source for searing foods indicating temperatures, and different angular positions of a shaft of the gas valve corresponding to different gas flow rates.

FIG. 6 shows a longitudinal section view of the main body of the thermostatic gas valve of the grill of FIG. 1.

FIG. 7A shows a front perspective view of the temperature indicator of the grill of FIG. 1.

FIG. 7B shows a side view of the temperature indicator of FIG. 7A.

### DETAILED DESCRIPTION

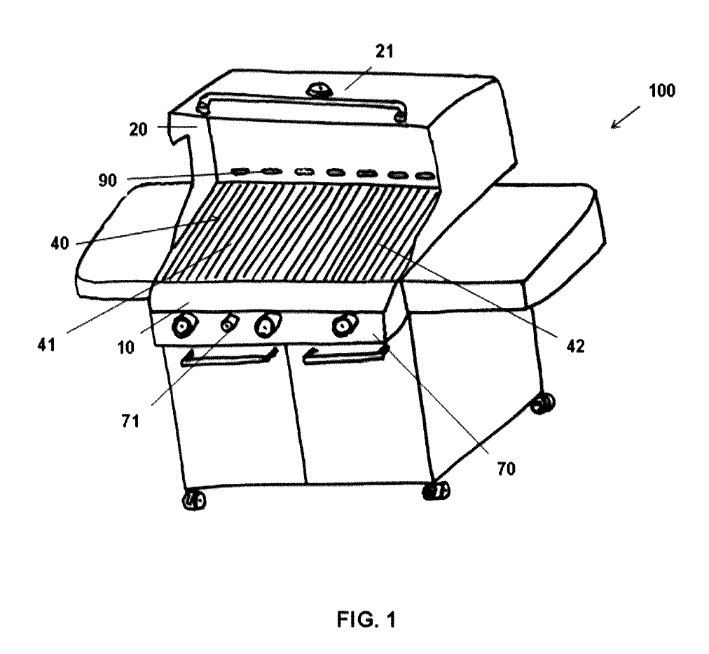

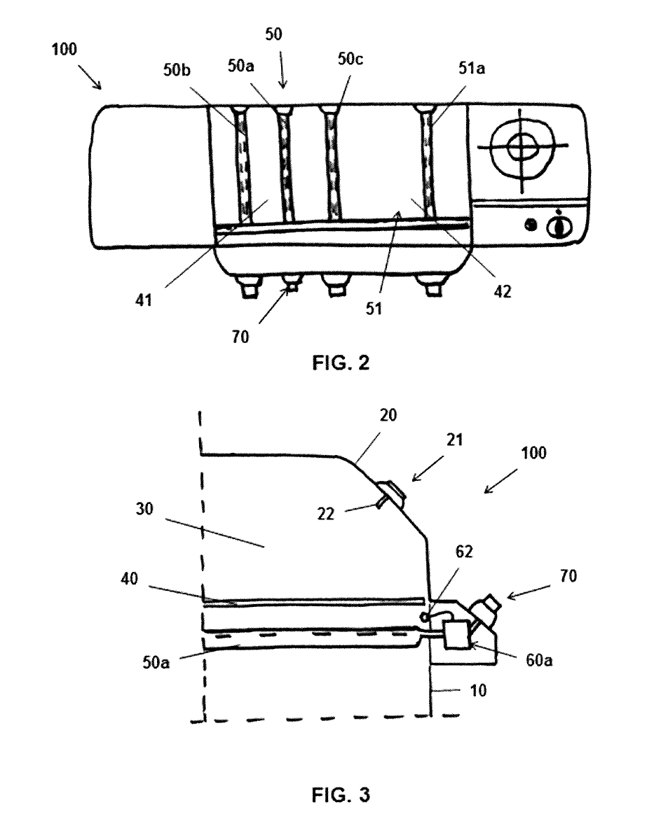

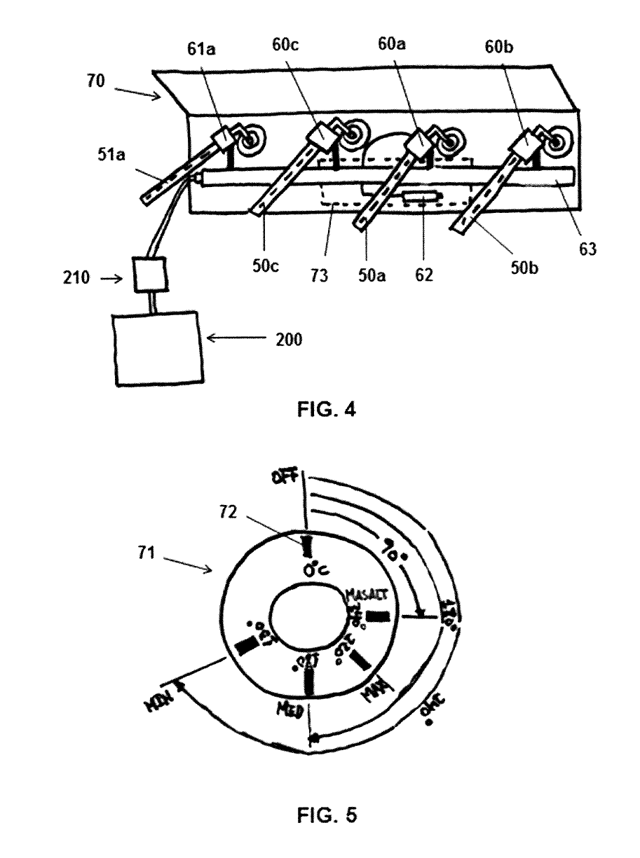

FIG. 1 shows a perspective view of a gas grill 100 according to one embodiment. FIG. 2 shows a plan view of the grill 100 of FIG. 1, in which the lid 20 and the grill grate used as the cooking surface 40 have been removed, and the burners 50a, 50b, 50c and 51a are shown. FIG. 3 shows a partial cross-section view of the grill 100 of FIG. 1 with the burner 50a and the thermostatic gas valve 60a of the heat source 50 for searing foods. FIG. 4 shows a partial rear perspective view of the control panel 70 with the gas valves 60a, 60b, 60c and 61a, and the respective burners 50a, 50b, 50c and 51a of the grill 100 of FIG. 1, as well as the connection of the gas distributor 63 of the grill 100 with the gas supply 200.

In this embodiment, the grill 100 comprises a support structure 10 which bears the cooking area on the upper part and storage areas in the lower part. The grill 100 also comprises a pivoting lid 20 on the structure 10 with a handle that makes it easier to use. Inside the structure 10, in the central upper part, the grill 100 comprises a cooking chamber 30 comprised between the inside of the structure 10 and the lid 20 when it is closed over the structure 10. In the cooking chamber 30, at about mid-height, there is a cooking surface 40, which is a grill grate in this embodiment, but in other embodiments of the grill it can be a griddle, for example. In this embodiment, the cooking surface 40 is divided into two areas depending on the heat sources located thereunder, i.e., a first area 41 and a second area 42.

The grill 100 shown comprises two heat sources, a first heat source 50 comprising three standard gas burners 50a, 50b and 50c and arranged below the first area 41, and a second heat source 51 comprising a standard gas burner 51a and arranged below the second area 42. The heat source 50 comprises a gas valve 60a that is fluidically connected with the burner 50a. The gas valve 60a regulates the rate of the gas flow coming from a gas supply source 200 towards the burner 50a. The gas coming from the gas supply source 200 is usual natural gas NG, or liquefied petroleum gas LPG. The gas goes through a gas pressure regulator 210, where the pressure of the gas used is regulated, and reaches a gas distributor 63 attached to the control panel 70 of the grill 100. The control knobs are arranged in the front part of this control panel 70, including among them control knob 71, corresponding to the gas valve 60a, and the gas distributor 63 is arranged in the rear part of the control panel 70. This gas distributor 63 allows distributing the gas coming from the gas supply source 200 to the different gas valves 60a, 60b, 60c and 61a, and from there the gas goes to the different burners 50a, 50b, 50c and 51a.

FIG. 5 shows a front view of the control knob 71 of the thermostatic gas valve 60a of the heat source 50 for searing foods indicating temperatures, and different angular positions of a shaft 64 of the corresponding gas valve at different gas flow rates. The gas valve 60a, which is fluidically communicated with the burner 50a, is a thermostatic gas valve which allows automatically regulating a temperature selected for the cooking chamber 30, and thereby being able to cook foods arranged on the cooking surface 40. The gas valve 60a allows variable control of the gas flow towards the burner 50a and to that end comprises different gas flow rate positions, these positions being in the embodiment of the gas valve 60a shown, a no gas flow position OFF, a minimum gas flow position MIN, a maximum gas flow position MAX, a progressive intermediate gas flow position MED comprised between the minimum gas flow MIN and maximum gas flow MAX, and a highest gas flow position MASALT corresponding with the food searing position. The highest gas flow position MASALT corresponding to a gas flow rate that is greater than that of the MAX gas flow position.

The control knob 71 is coupled to the shaft 64 of the gas valve 60a and allows the user to select the different gas flow rate positions by operating the control knob 71. These different angular positions are each associated with different temperatures indicated in the control knob 71, which in turn has marks 72 associated with the different angular positions corresponding to the different gas flow rates that the valve 60a can regulate. In this embodiment, these marks 72 indicate temperatures, as shown in FIG. 5, of the cooking chamber 30 of the grill 100, which temperatures, once selected by the user, can be automatically regulated by the thermostatic gas valve 60a, holding them steady within a range of the selected temperature. This means that nothing or no one has to intervene for the temperature to be held steady in the cooking chamber 30 of the grill 100. These marks 72 can indicate as an alternative to temperatures, or in addition to temperatures, cooking functions such as searing, roasting, etc., or they can also indicate foods to be cooked, such as chops, chicken, desserts, etc.

By way of example, when the user wants to cook chops, the chops are cooked directly over the heat source. First the cooking surface 40 is pre-heated with all the heat sources 50, 51 on maximum heating power for a given time, for example ten minutes, i.e., valves 60b, 60c and 61a on maximum MAX, and valve 60a in the highest flow rate position MASALT. Then heat source 50 is left switched on and heat source 51 switched off, and the chops are placed over the so-called searing station, corresponding with the first area 41 in this embodiment of the grill 100. The lid 20 is closed and only opened to check the state of the chops or for flip them over. After a few minutes, and according to the user's taste, when the chops are marked by the grill grate, the position of the valves 60a, 60b and 60c is adjusted to the user's taste until cooking has finished.

When the user wants to cook a whole chicken, for example, the chicken is cooked with the cooking chamber 30 of the grill 100 working like a conventional oven. To that end, first the lid 20 of the grill 100 is closed, and the cooking surface 40 is pre-heated with all the heat sources 50, 51 on maximum heat output for a given time, for example ten minutes, i.e., valves 60b, 60c and 61a on maximum MAX, and valve 60a in the highest flow rate position MASALT. Then heat source 50 is left on, and the heat source 51 is switched off, and the chicken is placed over the second area 42, below which area the heat source 51 is off. Therefore, the heat inside the cooking chamber 30 is regulated by the thermostatic valve 60a with heat reflected on the lid 20 and on the inner surfaces of the grill 100, and the chicken is cooked slowly, heat circulating in the cooking chamber 30 like in a convection oven.

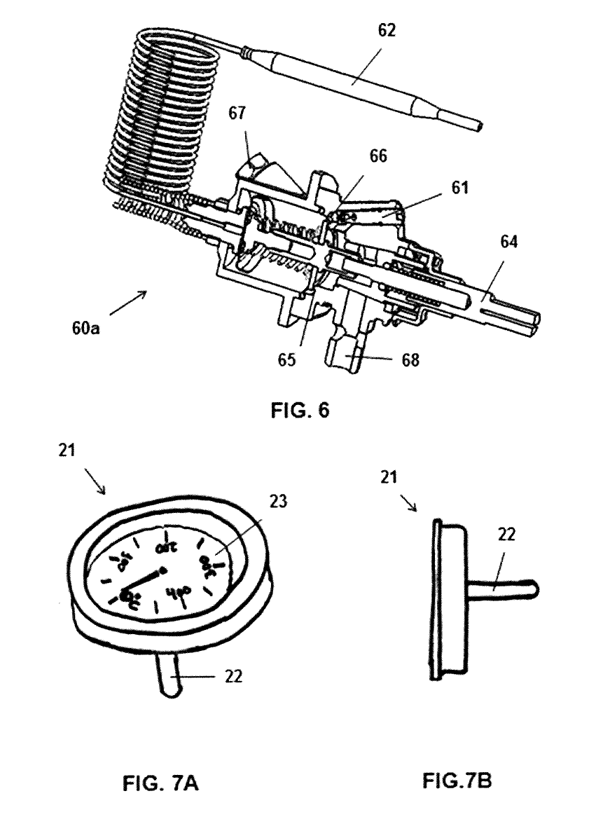

FIG. 6 shows a longitudinal section view of the main body of the thermostatic gas valve 60a of the grill 100 of FIG. 1. When the cooking chamber 30 works under indirect cooking, i.e., like an oven, as previously discussed, the thermostatic valve 60a functions to automatically maintain the temperature in the chamber 30 at a temperature selected by the user. However, if the grill 100 is not properly configured, it is possible that even in the event the temperature in the chamber 30 is being maintained solely by burner 50a with the thermostatic valve 60a in the minimum gas flow position MIN, the expulsion of heat from within the grill 100 towards the outside of the grill due to radiation phenomena from the lid 20, or due to convection phenomena from different openings existing in the lid and/or in the structure 10, is less than the expulsion of heat from the burner 50a. In such a case, the temperature inside the cooking chamber 30 would continue to gradually increase even with the gas valve 60a being in the minimum gas flow position MIN. This is because the thermostatic valve 60a includes a bypass conduit 61 that maintains the minimum gas flow MIN through the valve even when the main gas outlet 65 of the valve is closed. Under such a condition the thermostatic valve 60a would not be able to properly control the temperature within the chamber 30 to a temperature selected by a user of the grill. Although the thermostatic valve would attempt to adjust the temperature of the cooking chamber 30 to the pre-selected temperature by eventually closing the main gas outlet 65, the minimum gas flow would continue to flow through the valve to the external outlet 67.

As shown in FIG. 6, the bypass 61 fluidically connects the gas coming from the gas supply source 200 with the burner 50a, through a gas inlet 68 into the gas valve 60a, of the gas passage 66 of the bypass 61, towards the external outlet 67. In this embodiment of the gas valve 60a, the gas flow rate of the bypass 61 corresponds to the gas flow rate of the minimum gas flow position MIN. This gas flow through the bypass 61 allows keeping the flame in the burner 50a, such that the flame in the burner 50a never goes out.

As noted above, even when the gas valve 60a closes the main gas outlet 65 towards the burner 50a, and gas is only expelled through the external outlet 67 through the bypass 61, it is possible for the temperature to keep increasing up to a value that is greater than the value of the temperature selected for the cooking chamber 30. To avoid this, the grill 100 of the invention comprises a plurality of openings or vent holes 90 arranged in the support structure 10 and/or in the lid 20, which allow the expulsion of heat from the cooking chamber 30 to the outside to be equal to or greater than the expulsion of heat from the burner 50a towards the inside of the cooking chamber 30, when the gas valve 60a is in the minimum gas flow rate position MIN, and being able to reach any temperature selected for the cooking chamber 30.

FIG. 7A shows a front perspective view of the temperature indicator 21 of the grill 100 of FIG. 1, and FIG. 7B shows a side view of the temperature indicator 21 of FIG. 7A.

The lid 20 of the grill 100 may comprise a temperature indicator 21 that is arranged at about mid-height of the lid 20. In other embodiments of the grill 100 (not shown in the drawings), the temperature indicator 21 can be arranged in other areas of the lid 20 or at other points outside the structure 10 of the cooking chamber 30. The temperature indicator 21 may comprise a temperature sensor 22 having a cylindrical shaft shape, and when the temperature indicator 21 is assembled in the lid 20, the temperature sensor 22 points towards the inside of the cooking chamber 30. The temperature indicator 21 may also comprise in its main body, having a cylindrical box shape, a display 23 which in this embodiment comprises a needle and a circular graphic with different temperatures corresponding to the temperatures that the cooking chamber 30 can reach. The main body of the display 23 is assembled on the outside of the lid 20, such that the temperatures measured by the temperature sensor 22 and indicated by the needle of the display 23, are visible for the user without having to open the lid 20.

However, the temperature sensor 22 of the temperature indicator 21 indicates the environmental temperature inside the cooking chamber 30, and more specifically the temperature of the upper area of the cooking chamber 30. That temperature does not represent the cooking temperature of the foods which are located on the cooking surface 40, closest to the heat sources 50, 51. In order to determine the temperature closest to the foods to be cooked, the thermostatic gas valve 60a comprises a temperature detection element 62. In this embodiment of the gas valve 60a, the temperature detection element 62 is a sensitive element which is attached to the main body of the valve by means of a capillary tube. The temperature detection element 62 and the capillary tube internally comprise oil, which expands and contracts with the change in temperatures. When the temperature of the cooking chamber 30 increases, the oil expands and moves a plate located inside the main body of the gas valve 60a which regulates the gas flow through the main gas outlet 65 towards the external outlet 67 of the valve. The effect is the opposite when the temperature of the cooking chamber 30 decreases. Therefore, according to one embodiment of the grill 100 the temperature detection element 62 is arranged in the rear part of the control panel 70, at a height comprised between the height of the burner 50a and the height of the cooking surface 40. To prevent the temperature detection element 62 from being affected by drops of oil and juices from the foods as they are being cooked, the temperature detection element 62 is covered by a metal cover 73 which is attached to the rear part of the control panel 70.

Since there is a difference between the temperatures sensed by the temperature detection element 62 of the gas valve 60a and the temperatures sensed by the temperature sensor 22 of the temperature indicator 21, the user is actually interested in knowing the cooking temperatures of the foods, which are best represented by the temperatures sensed by the temperature detection element 62. By means of laboratory testing, for different cooking situations with different heat outputs from the heat sources 50, 51, a correlation is established between the temperatures sensed by the temperature detection element 62 and the temperatures sensed by the temperature sensor 22. Therefore, the temperatures shown on the display 23 are corrected with the correlation, and the display 23 shows the temperatures sensed by the temperature sensor 22 corrected with the existing correlation with the temperatures sensed by the temperature detection element 62 of the gas valve 60a. In another embodiment of the grill 100, the display 23 shows the temperatures sensed by the temperature detection element 62 of the gas valve 60a and the temperatures sensed by the temperature sensor 22 of the temperature indicator 21, allowing the user to know both temperatures.

In another embodiment of the grill 100 (not shown in the drawings), the gas valve 60a comprises control means basically consisting of an electronic device comprising a transducer that converts a mechanical signal coming from the expansion and contraction of the oil of the capillary tube and the temperature detection element 62 of the gas valve 60a, into an electric signal, and an emitter which converts the signal electric and emits it by radio frequency for example. The control means receives the temperatures sensed by the temperature detection element 62 of the gas valve 60a, transform them into electric signals, and emit them towards the display 23 of the temperature indicator 21. The display 23 comprises a signal receiver and converts the signals into temperatures that can be shown, the temperatures directly being the temperatures sensed by the temperature detection element 62 of the gas valve 60a. The signals obtained in the control means can also be emitted towards external control units, such as remote control units, for example, that users outside their homes can take with them, and they can therefore constantly know the cooking temperature of the foods. Furthermore, in this embodiment the display 23 can show the temperatures sensed by the temperature detection element 62 directly and the temperatures sensed by the temperature sensor 22.

In the embodiment of the grill 100 shown in the figures, the heat source 50, arranged below the first area 41, comprises burners 50a, 50b and 50c, and the corresponding gas valves 60a, 60b and 60c. As discussed above, the thermostatic gas valve 60a comprises a highest gas flow rate position MASALT. The gas valves 60b and 60c are standards valves comprising different gas flow rate positions, these positions being a no gas flow position OFF, a minimum gas flow position MIN, a maximum gas flow position MAX, and a progressive intermediate gas flow position MED comprised between the minimum MIN and the maximum MAX gas flow. The maximum gas flow position MAX of gas valves 60b and 60c corresponds with the maximum gas flow position MAX of gas valve 60a, the highest gas flow rate position MASALT of the gas valve 60a providing a gas flow rate greater than that of the maximum gas flow rate position MAX of gas valves 60b and 60c. The heat source 51, arranged below the second area 42, comprises the burner 51a and the corresponding gas valve 61a. This gas valve 61a is similar to gas valves 60b and 60c and comprises the same gas flow positions and rates, such that the highest gas flow rate position MASALT of the gas valve 60a has a gas flow rate greater than that of the maximum gas flow rate position MAX of the gas valve 61a. Therefore, when the heat sources 50 and 51 are started up, and each of their gas valves are set to the maximum heat output position, the maximum expulsion of heat from the heat source 50 towards the first area 41 of the cooking surface 40 is greater than the maximum expulsion of heat from the heat source 51 towards the second area 42. Even if the heat sources 50, 51 had the same number of burners, but heat source 50 is regulated by the thermostatic gas valve 60a with the highest gas flow rate position MASALT, the maximum expulsion of heat from the heat source 50 would still be greater than that of the heat source 51.

Other embodiments of the grill 100 allow dividing the cooking surface 40 into more areas, in addition to the first and second areas 41, 42. Those successive cooking areas can have heat sources therebelow where the maximum expulsion of heat from same is less than the maximum expulsion of heat from the heat source 50 towards the first area 41. Therefore, the first area or searing station allows cooking foods directly, but it furthermore has the heat output required for being able to sear the foods. The cooking surface 40 can comprise more searing stations with a combination of burners forming one or more searing stations. That is, the cooking surface 40 may comprise more than one first area 41, each of these first areas 41 with a heat source comprising a gas burner 50a with a thermostatic gas valve type as defined above, and at least one gas burner with a standard gas valve. The cooking surface 40 may also comprise more than one second area 42, each of these second areas 42 with a heat surface comprising at least one gas burner with a standard gas valve. The cooking surface 40 can thus include any of a variety of combinations of areas 41, 42.

What is claimed is:

1. A gas grill, comprising
a support structure,
a lid moveable between an open position and a closed position,
a cooking chamber comprised between the inside of the support structure and the lid when the lid is in the closed position,
a cooking surface arranged in the support structure, the cooking surface having a first area and a second area,
a first heat source arranged below the first area of the cooking surface, the first heat source including a first burner; and
a first gas valve in fluid communication with the first burner, the first gas valve configured to regulate the flow rate of a gas to the first burner, the first gas valve comprising a highest gas flow rate operating configuration (MASALT) which allows the searing of foods arranged in the first area of the cooking surface, the first gas valve being a thermostatic gas valve which allows automatically regulating a temperature selected for the cooking chamber.

2. The gas grill according to claim 1, wherein the first gas valve comprises a control that sets the gas flow rate operating configuration of the first gas valve between at least two operating configurations, the at least two operating configurations including the highest gas flow rate operating configuration (MASALT) and a second gas flow rate operating configuration, the highest gas flow rate operating configuration (MASALT) corresponding to the highest attainable gas flow rate through the first gas valve, the second gas flow rate operating configuration corresponding to a gas flow rate less than the highest attainable gas flow rate.

3. The gas grill according to claim 2, wherein the control is a control knob coupled to the first gas valve that allows a user to select between the at least two operating configurations.

4. The gas grill according to claim 1, wherein the first gas valve comprises a control that sets the gas flow rate operating configuration of the first gas valve between a no gas flow operating configuration (OFF), a minimum gas flow rate operating configuration (MIN), a maximum gas flow rate operating configuration (MAX), a progressive intermediate gas flow rate operating configuration (MED) comprised between the minimum gas flow rate operating configuration (MIN), and the maximum gas flow rate operating configuration (MAX), and the highest gas flow rate operating configuration (MASALT).

5. The gas grill according to claim 3, wherein the control knob comprises at least first and second marks, the first mark being a first temperature value associated with the highest gas flow rate operating configuration (MASALT), the second mark being a second temperature value associated with the second gas flow rate operating configuration, the first temperature value being greater than the second temperature value.

6. The gas grill according to claim 2, wherein the second gas flow rate operating configuration corresponds with a minimum gas flow rate operating configuration (MIN), the gas grill being configured so that the expulsion of heat from the cooking chamber to outside the chamber is equal to or greater than the expulsion of heat from the first burner when the first gas valve is in the second gas flow rate operating configuration.

7. The gas grill according to claim 6, wherein the support structure and/or the lid comprise a plurality of openings communicating the inside of the cooking chamber to the ambient environment, the plurality of openings facilitating the expulsion of heat from the cooking chamber.

8. The gas grill according to claim 6, wherein the first gas valve comprises a main gas outlet passage through which gas is supplied to the first burner when the first gas valve is in the highest gas flow rate operating configuration, the main gas outlet passage being closed when the first gas valve is in the second gas flow rate operating configuration, the first gas valve including a bypass through which the flow of gas is solely directed to the first gas burner when the first gas valve is in the second gas flow rate operating configuration.

9. The gas grill according to claim 6, wherein the first gas valve comprises third and fourth operating configurations, the fourth operating configuration corresponding to a maximum gas flow rate operating configuration (MAX), the third operating configuration corresponding to a progressive intermediate gas flow rate operating configuration (MED) comprised between the minimum gas flow rate operating configuration (MIN) and the maximum gas flow rate operating configuration (MAX).

10. The gas grill according to claim 1, further comprising a first temperature sensor arranged in the support structure, the gas grill further comprising a temperature indicator located on and externally to the lid that is operably coupled to a second temperature sensor located inside the lid, the temperature indicator displays a temperature of the combustion chamber, the displayed temperature resulting from a correlation of the temperature sensed by the first and second temperature sensors.

11. The gas grill according to claim 10, wherein the first gas valve is at least in part controlled by the first temperature sensor.

12. The gas grill according to claim 10, wherein the first temperature sensor is located nearer the first heat source than the second temperature sensor.

13. The gas grill according to claim 10, wherein the first temperature sensor is located nearer the first burner than the second temperature sensor.

14. The gas grill according to claim 10, wherein the first temperature sensor is arranged between the first burner and the cooking surface.

15. The gas grill according to claim 10, wherein the temperature indicator also displays the temperatures sensed by each of the first and second temperature sensors.

16. The gas grill according to claim 11, further comprising a first gas valve controller that is capable of (a) determining the temperature sensed by the first temperature sensor, (b) transforming the sensed temperature into a signal and (c) transmitting the signal to the temperature indicator or to a control unit external to the gas grill.

17. The gas grill according to claim 1, further comprising a second heat source arranged below the second area of the cooking surface, the designed maximum expulsion of heat from the first heat source towards the first area of the cooking surface is greater than the designed maximum expulsion of heat from the second heat source towards the second area of the cooking surface.

18. The gas grill according to claim 17, wherein the first heat source comprises a second burner located on a first side of the first burner and a third burner located on a second side of the first burner, the second side being opposite the first side, the gas grill further comprising second and third gas valves that respectively regulate the flow of gas to the second and third burners, the maximum attainable gas flow rate through each of the second and third gas valves being less than the maximum attainable gas flow rate through the first gas valve.

19. The gas grill according to claim 17, wherein the second heat source comprises a fourth burner, the gas grill further comprising a fourth gas valve that regulates the flow of gas to fourth burner, the maximum attainable gas flow rate through the fourth gas valve being less than the maximum attainable gas flow rate through the first gas valve.
